(19) United States
(12) Patent Application Publication
(10) Pub. No.: US 2007/0202382 A1
(43) Pub. Date: Aug. 30, 2007

(54) Solid Electrolyte Fuel Cell

(76) Inventors: Shin Nakamura, Tokyo (JP); Hideaki Sasaki, Tokyo (JP); Shoji Sekino, Tokyo (JP); Takeshi Obata, Tokyo (JP); Tsutomu Yoshitake, Tokyo (JP); Yoshimi Kubo, Tokyo (JP); Kenji Kobayashi, Tokyo (JP)

Correspondence Address: DICKSTEIN SHAPIRO LLP, 1177 AVENUE OF THE AMERICAS (6TH AVENUE), NEW YORK, NY, 10036-2714, US

(21) Appl. No.: 10/599,102

(22) PCT Filed: Mar. 22, 2005
(86) PCT No.: PCT/JP05/05164

§ 371 Date: Sep. 19, 2006

(30) Foreign Application Priority Data
Mar. 19, 2004 (JP) 2004-081715

(51) Int. Cl. H01M 8/02

(52) U.S. Cl. 429/38

(57) ABSTRACT

Output properties of a fuel cell can be improved by using a single cell structure 1387 having an anode 102 and an oxidizing agent electrode 108 in both sides of a solid electrolyte membrane 114 and an evaporation inhibiting layer 1388 covering the surface of the cathode 108 which is not in contact with the solid electrolyte membrane 114.

### TECHNICAL FIELD

The present invention relates to a solid electrolyte fuel cell.

### BACKGROUND OF THE INVENTION

A solid electrolyte fuel cell is composed of an anode, a cathode and a solid electrolyte membrane between them. A fuel and an oxidizing agent supplied to the anode and the cathode, respectively, and the solid electrolyte fuel cell is subjected to an electrochemical reaction to generate electric power. Each of the anode and the cathode has a substrate (an anode collector and a cathode collector) and a catalyst layer on the substrate surface. Although hydrogen is commonly used as a fuel, there have been intensely developed methanol-reformed type fuel cells where hydrogen is generated by reforming methanol as a starting material which is inexpensive and easily handled and direct type fuel cells which directly utilize methanol as a fuel (hereinafter, simply referred to as “DMFC”).

In a DMFC, an anodic reaction is represented by the following equation (1):
CH₃OH+H₂O→6H⁺+CO₂+6e⁻ (1)

A cathodic reaction is represented by the following equation (2):
3/2O₂+6H⁺+6e⁻→3H₂O (2)

As described above, a DMFC generates hydrogen ions from an aqueous methanol solution and thus eliminates the use of a reformer, resulting in size and weight reduction. Furthermore, its energy density is very high because it uses an aqueous methanol solution as a fuel.

It is known that in a DMFC, permeation of an aqueous methanol solution from an anode side through a solid electrolyte membrane (crossover) tends to take place, and that in a cathode side, a reaction efficiency in equation (2) is reduced due to a phenomenon “flooding”, where water generated from the reaction and water reaching the cathode side via crossover plug a path for gas diffusion in the cathode, leading to inhibition of the gas diffusion. For improving the properties of a fuel cell having such a configuration, water generated in the cathode must be quickly removed by evaporation from the cathode.

There have been proposed a variety of methods for preventing flooding. For example, Japanese Patent Laid-open No. 1997-245800 has proposed that drainage from a cathode can be improved by endowing the surface of an electrode substrate constituting a cathode with water repellency.

As another technique for preventing crossover in a DMFC, for example, Japanese Patent Laid-open No. 2000-106201 has proposed a fuel cell comprising a fuel vaporization layer for supplying a vaporized fuel and a fuel permeation layer formed on the fuel vaporization layer, which feeds a supplied liquid fuel to the fuel vaporization layer. There has been described that the DMFC technique where a fuel is supplied via vaporization can prevent crossover and thus flooding.

However, there has been found a problem that according to the method described in Japanese Patent Laid-open No. 1997-245800, water repellency in an electrode substrate surface causes excessive discharge of water from the cathode. Furthermore, there has been found a new problem in the method described in Japanese Patent Laid-open No. 2000-106201 that water generated in a cathode is excessively evaporated during supplying and evacuating of an oxidizing agent.

Thus, when a cathode is dried due to excessive evaporation of water, its proton conductivity is reduced, leading to significant reduction in a reaction efficiency in equation (2). A solid electrolyte membrane transfers protons generated in the reaction of equation (1) to a cathode, allowing the reaction of equation (2) to efficiently proceed. However, excessive drying of the cathode leads to drying of the solid electrolyte membrane, which reduces proton conductivity in the solid electrolyte membrane, resulting in a problem of inhibition of proton migration from the anode to the cathode.

For preventing flooding, it is preferable, as described above, to removing water from a cathode by evaporation, but unduly removing water from a cathode has caused significant reduction in a reaction efficiency in equation (2), leading to considerably deteriorated cell properties. Thus, it has been necessary to keep a suitable low water content in the cathode within a range where crossover or flooding is avoided and the reaction in equation (2) occurs.

There have been various attempts to keep a low water content in a cathode. For example, a technique disclosed in Japanese Patent Laid-open No. 2003-68330 employs a configuration having a dense water-retentive resin layer dispersing 50% or more by weight of carbon black as a conducting material on a cathode. Furthermore, there has been described that in this technique, the water-retentive resin layer has through-holes. The water-retentive resin layer must have properties of drying resistance, electricity supply and stable supplying of an oxidizing agent in this method. However, as the water-retentive resin layer retains water and thus an inner water content increases, the state of inner pores is changed, leading to difficulty in stably supplying electricity or supplying an oxidizing agent. This water-retentive resin layer containing carbon black is electrically conductive and must be, therefore, electrically insulated from, for example, another electrode. Thus, when forming a structure in which each cell has a moisturizing layer, there are many limitations in device designing such as the unusability of a metallic fixing jig and necessity of a certain distance between adjacent cell and the moisturizing layer.

A highly insulative resin as a water-retentive resin layer might be added to an electrode to improve water retentivity. However, even when using such a water-retentive material, there is a problem that as a water content increases, the state of inner pores is changed, leading to reduced oxygen permeability.

Furthermore, as another method for keeping water content in a cathode low, Japanese Patent Laid-open No. 2003-331900 has disclosed that a oxygen permeable and water-absorbing layer is formed on a collector for absorbing water generated in a cathode. However, a water-retentive material as described in Japanese Patent Laid-open No. 2003-331900 significantly swells as retaining water. Thus, since such a water-retentive material is added to an electrode, the electrode itself may swell, leading to destruction of an MEA or difficulty in stable oxygen supplying.

### SUMMARY OF THE INVENTION

As described above, utilization efficiency is higher and a water content in a cathode is reduced in a DMFC where an electrode substrate surface is made of a water-repellent material and a fuel is vaporized for preventing crossover or flooding. There is, however, a new problem that water content may be unduly reduced, so that a cathode may be dried not as expected in a conventional DMFC.

When a water-absorbing layer which absorbs water generated in a cathode is formed for preventing the above problem, the state of inner small pores is changed as a water content in the water-absorbing layer increases, leading to difficulty in stable supplying of an oxidizing agent or in maintaining conductivity. It has been thus difficult in a cell having a conventional configuration to maintain a suitable low water content of a cathode or to maintain constant water-retentive layer properties regardless of a water content.

In view of the above problems, an objective of this invention is to provide a technique where an evaporation inhibiting layer is formed, allowing a low water content in a cathode suitable for use to be maintained, making the state of inner small pores resistant to change due to variation in a water content and allowing an oxidizing agent to be stably supplied to a cell, resulting in improvement in output properties of a fuel cell.

In accordance with the present invention, there is provided a solid electrolyte fuel cell comprising a laminate of a limited fuel-permeating part, an anode collector, an anode catalyst layer, a solid electrolyte membrane, a cathode catalyst layer, a cathode collector and an evaporation inhibiting layer in sequence, wherein the evaporation inhibiting layer is made of a material having venting pores and covers at least part of the surface of the cathode collector. The term “a venting pore” as used herein refers to a pore communicating one and the other surfaces of an evaporation inhibiting layer, which allows for supplying an oxidizing agent, and includes those having various pore sizes from the order of nanometers to the order of millimeters.

An evaporation inhibiting layer in the present invention is formed for preventing excessive drying of a cathode by an oxidizing agent flow without excessively absorbing water generated in the cathode to maintain a low water content suitable for use.

An evaporation inhibiting layer in the present invention retains water by adsorption, absorption or other when a water content in a cathode is increased due to water generated in the cathode. Furthermore, when a water content becomes too low in the cathode under certain use conditions of a cell, it transfers water from the evaporation inhibiting layer to the cathode by desorption, dehydration or elimination of water depending on a water-content difference between the evaporation inhibiting layer and the cathode. Thus, the evaporation inhibiting layer in the present invention has a function of maintaining a low water content of the cathode suitable for use. Furthermore, the evaporation inhibiting layer of the present invention has an inner supplying path for an oxidizing agent, which does not inhibit supplying of the oxidizing agent even when a water content in the evaporation inhibiting layer increases, allowing for stable supplying of the oxidizing agent.

A mechanism of water retention by an evaporation inhibiting layer may be chemical or physical adsorption, or capillary condensation or other as long as it allows for water retention in the evaporation inhibiting layer.

A difference in a water content between the evaporation inhibiting layer and the cathode as water migration is initiated from the evaporation inhibiting layer to the cathode depends on various conditions such as a humidity of an ambient air, the amount of an oxidizing agent supplied and a temperature. The water migration can be controlled by adjusting the type of a component for the evaporation inhibiting layer, a size of the venting pore and a porosity. Once a desired water-content difference is obtained between the evaporation inhibiting layer and the cathode by setting these conditions, water can be migrated from the evaporation inhibiting layer into the cathode.

A material suitable for an evaporation inhibiting layer of this invention has a volume expansion coefficient (a volume increase rate between before and after water absorption) of 4.5 or less, preferably 2 or less, and initiates water migration from the evaporation inhibiting layer to the cathode at a temperature of 80° C. or lower. If these conditions are not met, the following problems may be caused.
If a volume expansion coefficient is too high, an MEA is broken prior to breakage of a case;
Expansion may inhibit oxygen diffusion (occlusion of venting pores);
Unless water migration is initiated at an operation temperature of the fuel cell, drying of the cathode can not be properly dealt with.

Examples of a material suitable for an evaporation inhibiting layer of the present invention include woven and unwoven fabrics containing fibrous cellulose as a main component. A material containing fibrous cellulose as a main component retains water in voids formed among fibers. A volume expansion coefficient before and after water absorption is two-folds or less, and water retained in the voids can migrate from the evaporation inhibiting layer to the cathode when at a usual operation temperature of the fuel cell, a water-content difference between the evaporation inhibiting layer and the cathode reaches a predetermined value.

Materials such as polyacrylamide used as a water absorbing layer in the above technique described in Japanese Patent Laid-open No. 2003-331900 are not suitable as an evaporation inhibiting layer in the present invention. These materials expands ten- or more fold by excessively absorbing water generated in a cathode and at an operation temperature of the fuel cell, can migrate a relatively smaller amount of water from the evaporation inhibiting layer into the cathode even when a water content in the cathode is adequately low. Thus, when these materials are used a cell of the present invention having a limited fuel-permeating part, they may cause water deficiency in the cathode, leading to difficulty in stable generation of electricity.

Materials such as foam metals and porous PTFEs whose pore voids can retain water may be also used as an evaporation inhibiting layer. When having a water-retaining function, a porous plate member such as a punching plate may be disposed in an inlet of an oxidizing agent, a oxidizing-agent supplying surface or the like. In particular, a metal punching plate exhibits higher heat conduction and accelerates water retention in an internal surface (cathode side), and is, therefore, effective in inhibiting evaporation.

Within the foam metals, porous PTFE and punching plates, there are holes such as venting pores and micro-voids yielded during forming the venting pores (during foaming to make a foam metal, extending a porous PTFE or mechanically opening pores in a punching plate). Thus, it is conceivable that there might complexly take place water-retaining actions such as adsorption, capillary condensation and others in these materials.

These evaporation inhibiting layers may be adequately effective alone, but for example, a combination of fibrous cellulose and a punching plate can more effectively inhibit water evaporation from the cathode surface, allowing for stable electricity generation for a long period.

In an aspect in which an evaporation inhibiting layer is in contact with a cathode, the evaporation inhibiting layer may be directly in contact with a collector in an oxidizing agent electrode side in the cathode. Thus, an adequate amount of the oxidizing agent for an electrode reaction in the cathode is uniformly supplied in the whole surface of the cathode while water generated in the cathode is retained at least in the cathode surface by the evaporation inhibiting layer, so that excessive drying of the cathode can be prevented. Alternatively, the evaporation inhibiting layer may be in contact with the cathode via a material which does not inhibit migration of an oxidizing agent or water between the evaporation inhibiting layer and the cathode. For example, a solid electrolyte fuel cell of the present invention may have a configuration where the evaporation inhibiting layer is in contact with the surface of the cathode side collector.

A solid electrolyte fuel cell of the present invention may have a container adjacent to the limited fuel-permeating part, for reserving a liquid fuel supplied to a catalyst layer in the fuel electrode side via the anode side collector. Thus, a liquid fuel in the container can be reliably supplied to the anode through the limited fuel-permeating part and the fuel cell can be reduced in size.

A solid electrolyte fuel cell of the present invention may have a fuel-absorbing member which is place opposite to the limited fuel-permeating part and absorbs the liquid fuel. The fuel cell may have a fuel-absorbing member which is adjacent to a part of the limited fuel-permeating part and absorbs the liquid fuel, and a gas discharging part which discharges gas generated from a cell reaction, in an area separate from the fuel-absorbing member in the limited fuel-permeating part. Thus, gas such as carbon dioxide generated in the anode can be reliably discharged from the gas discharging part to the outside of the anode. It can significantly reduce inhibition of migration a fuel in the anode due to retention of carbon dioxide in the anode, to stabilize output properties of the fuel cell.

Any combination of these configurations and any variation of the present invention interchangeably expressed between a process and an apparatus are also effective as aspects of the present invention.

As described above, this invention provides a technique for improving output properties of a fuel cell.

### BRIEF DESCRIPTION OF THE DRAWINGS

FIG. 1 is a cross-sectional view schematically showing a configuration of a single cell structure in accordance with an embodiment of the present invention.

FIG. 2 is a plan view showing a configuration of a fuel cell in accordance with an embodiment of the present invention.

FIG. 3 is a cross-sectional view schematically showing a configuration of a single cell structure in accordance with an embodiment of the present invention.

FIG. 4 is a cross-sectional view showing a configuration of a fuel cell having a single cell structure.

FIG. 5 is a view showing output properties of a fuel cell in accordance with an example.

### DETAILED DESCRIPTION OF THE INVENTION

There will be described embodiments of the present invention with reference to the drawings. In all figures, a common component is designated by the same symbol, whose description is omitted as appropriate.

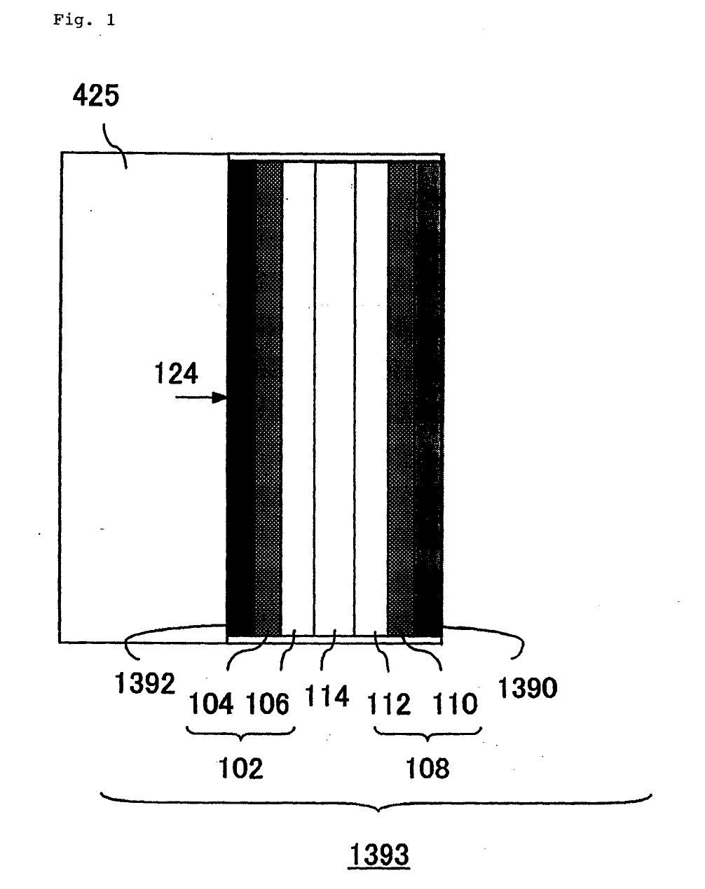

FIG. 1 is a cross-sectional view showing a configuration of a single cell structure 1393 in a fuel cell in accordance with this embodiment. In FIG. 1, the single cell structure 1393 comprises an anode 102 (including an anode collector 104 and an anode catalyst layer 106), a cathode 108 (including a cathode catalyst layer 112 and a cathode collector 110), a solid electrolyte membrane 114 and an evaporation inhibiting layer 1390. The surface of the anode 102 constituting the single cell structure 1393 has a fuel-permeation inhibiting layer 1392, via which a container 425 is attached.

A fuel 124 in the container 425 is supplied to the anode 102 in the single cell structure 1393 through the fuel-permeation inhibiting layer 1392. An oxidizing agent 126 is supplied to the cathode 108 in each single cell structure 1393. Examples of the fuel 124 include methanol, ethanol or the other alcohols; ethers such as dimethyl ether; liquid hydrocarbons such as cycloparaffins; and liquid fuels such as formalin, formic acid and hydrazine. The liquid fuel may be an aqueous solution. The oxidizing agent 126 may be typically air or may be oxygen gas.

The evaporation inhibiting layer 1390 is formed adjacently to the face opposite to the solid electrolyte membrane 114 in a substrate (cathode side collector) 110 in the single cell structure 1393. In a fuel cell having the single cell structure 1390, the whole surface of the evaporation inhibiting layer 1390 may be exposed, or alternatively, there may be a supplying path for the oxidizing agent 126 such that the evaporation inhibiting layer 1390 is exposed. Although the evaporation inhibiting layer 1390 covers the whole surface not in contact with the catalyst layer 112 in the cathode side of the substrate 110 in FIG. 1, the evaporation inhibiting layer 1390 may cover a part of the surface of the substrate 110. By forming the evaporation inhibiting layer 1390 over the whole surface of the substrate 110, water can be reliably retained in the evaporation inhibiting layer 1390 to suitably prevent excessive drying of the cathode 108. Thus, it can further prevent drying of the catalyst layer 112 in the cathode side and the solid electrolyte membrane 114. Since the oxidizing agent 126 is absorbed from the whole surface of the evaporation inhibiting layer 1390, a cell reaction can uniformly proceed in the whole surface of the cathode 108.

The evaporation inhibiting layer 1390 can retain water in its surface or internal voids by adsorption or absorption water, and so on. Furthermore, when the evaporation inhibiting layer 1390 has a hydrophilic surface, the evaporation inhibiting layer 1390 can actively retain water in the substrate 110. As a result, the substrate 110 can retain water generated by a cell reaction in the catalyst layer 112 in the cathode side to a proper amount. Consequently, when a water content in the catalyst layer 112 in the cathode side and the solid electrolyte membrane 114 becomes so low that the cell cannot be properly used, water migrates from the evaporation inhibiting layer into these members to prevent drying of the catalyst layer 112 in the cathode side and the solid electrolyte membrane 114. Thus, protons can be efficiently moved in the solid electrolyte membrane 114 and protons generated in the anode 102 can be rapidly moved to the cathode 108. Finally, adequate proton conductivity can be attained in the cathode 108, resulting in improvement in cell properties.

The evaporation inhibiting layer 1390 has microscopic venting pores which allow an oxidizing agent to penetrate and communicate both sides of the layer. An example of an evaporation inhibiting layer of the present invention may be an evaporation inhibiting layer 1390 having a fiber sheet prepared by forming a fibrous material into a sheet on the surface of the substrate 110. The evaporation inhibiting layer having such a configuration ensures adequate water-retention capacity so that the oxidizing agent 126 can be reliably supplied to the cathode 108 via the venting pores.

Such a fibrous material may be a material having a volume expansion coefficient of 4.5 or less and capable of initiating water migration from the evaporation inhibiting layer to the cathode at a temperature of 80° C. or lower. By selecting such a material, destruction of an MEA due to expansion of the evaporation inhibiting layer 1390 can be avoided and excessive drying of the cathode can be prevented by water migration from the evaporation inhibiting layer to the cathode at 80° C. or lower as necessary while maintaining capability of adsorbing or absorbing water.

The material having a volume expansion coefficient of 4.5 or less and capable of initiating water migration from the evaporation inhibiting layer to the cathode at a temperature of 80° C. or lower may be an unwoven or woven fabric consisting of one or more of the following water-retentive polymers. Examples of a water-retentive polymer include polysaccharides such as cellulose; polyvinyl alcohols; polyethylene oxides; polyethylene glycols; polyesters; and styrene-divinyl benzenes.

Among those described above, a water-retentive fiber sheet such as a fibrous cellulose sheet made of a fibrous cellulose such as biocellulose and cotton cellulose can be suitably used because it exhibits good balance between water retentivity and oxygen permeability.

When forming venting pores in the evaporation inhibiting layer 1390 using a fiber sheet, a wire diameter of the fiber may be about 10 to 50 μm. Herein, a porosity may be about 70 to 90% and a thickness may be about 30 to 300 μm.

The evaporation inhibiting layer 1390 having microscopic venting pores communicating both sides of the layer may be made of a porous material capable of permeating the oxidizing agent 126. Examples of such a porous material include foam metals and porous PTFE (polytetrafluoroethylene).

A porous PTFE may be prepared by making an extruded PTFE porous by stretching. It can be stretched either in an MD direction (parallel to a PTFE conveying direction) or in a TD direction (perpendicular to the PTFE conveying direction) or both. An internal pore size may be controlled by adjusting the stretching direction and/or a stretching rate.

In the porous PTFE, a dry size of its venting pores is for example 3 nm or more, preferably 10 nm or more. Thus, the oxidizing agent 126 can be reliably supplied to the cathode 108. The dry size of the venting pores may be for example 20 nm or less, preferably 15 nm or less. Thus, evaporation of water from the single cell structure 1393 can be reliably prevented and when the cathode becomes water-deficient, water can be migrated from the evaporation inhibiting layer to the cathode. A dry size of the venting pores may be determined by, for example, SEM observation of the venting pores in the cross-section of the evaporation inhibiting layer.

When using a foam metal, a dry size of the venting pores may be as in the above porous PTFE. A foam metal means a porous metal which has a large number of foams in a metal matrix; specifically, a metal material with a high porosity because of a network of frames with a diameter of about 0.05 to 1.0 mm. Examples of such a metal include nickel, nickel—chromium alloys, copper and copper alloys, silver, aluminum alloys, zinc alloys, lead alloys and titanium alloys, but not necessarily limited to them because any metal having a small electric resistance may be used.

When using such a foam metal or porous PTFE, a porosity of the evaporation inhibiting layer 1390 may be for example, 30% or more, preferably 50% or more. Thus, the oxidizing agent 126 can be reliably supplied to the cathode 108. A porosity of the evaporation inhibiting layer 1390 may be for example 90% or less, preferably 85% or less, more desirably 60 to 80%. Thus, evaporation of water from the single cell structure 1393 can be reliably prevented and when the cathode becomes water-deficient, water can be migrated from the evaporation inhibiting layer to the cathode. A porosity of the evaporation inhibiting layer 1388 may be determined by, for example, measuring a rate of the venting pores in the cross-section of the evaporation inhibiting layer by SEM observation.

In an evaporation inhibiting layer using a foam metal or PTFE as described above, both sides of the evaporation inhibiting layer are communicated each other via venting pores so that an oxidizing agent can permeate the evaporation inhibiting layer.

The evaporation inhibiting layer 1390 may be made of a material having venting pores allowing for permeation of the oxidizing agent 126; for example, a metal plate such as an aluminum plate and a stainless plate having pores for supplying an oxidizing agent and a punching plate such as a plastic plate including a PTFE plate having holes for supplying an oxidizing agent. A punching plate is a plate material having regular or irregular pores formed by a mechanical method. Examples of a hole-forming method for a punching plate may include, but not limited to, punching and drilling.

The pores for supplying an oxidizing agent may have a size of, for example, 1 μm or more, preferably 10 μm or more. Thus, the oxidizing agent 126 can be reliably supplied to the cathode 108. The size of the pores for supplying an oxidizing agent may be for example 1000 μm or less, preferably 500 μm or less. It may ensure retention of water by the evaporation inhibiting layer 1388.

A numerical aperture in the punching plate may be for example 10% or more, preferably 30% or more. Thus, the oxidizing agent 126 can be reliably supplied to the cathode 108. A numerical aperture in the evaporation inhibiting layer (punching plate) 1388 may be for example 90% or less, preferably 70% or less. It may ensure retention of water by the evaporation inhibiting layer 1388.

In an evaporation inhibiting layer using a punching plate such as a metal plate or a PTFE plate described above, both sides of the evaporation inhibiting layer are communicated each other via venting pores for allowing for permeation of an oxidizing agent.

The evaporation inhibiting layer may have a multilayer structure as a combination of a fibrous material, a foam metal or porous PTFE (polytetrafluoroethylene) having venting pores and/or a punching plate made of a plastic plate such as a metal plate and a PTFE plate as described above.

The evaporation inhibiting layer 1390 may have, for example, a dry thickness of 1 μm or more, preferably 30 μm or more in the light of requirement in mechanical strength for maintaining a structure. Since the evaporation inhibiting layer 1390 must efficiently permeate the oxidizing agent 126, it is desirably thin. For example, a dry thickness of the evaporation inhibiting layer 1390 may be 500 μm or less, preferably 100 μm or less. For example, when using a fibrous cellulose sheet, such an evaporation inhibiting layer 1390 can be reliably formed.

In the single cell structure 1393, the evaporation inhibiting layer 1390 can be formed such that it covers the outer surface of the cathode 108, to reliably prevent excessive drying of the catalyst layer 112 in the cathode side and the solid electrolyte membrane 114 while ensuring supply of the oxidizing agent 126 to the cathode 108. Thus, the single cell structure 1393 can stably provide a higher output for a long period.

The solid electrolyte membrane 114 separates the anode 102 from the cathode 108 while transferring hydrogen ions between them. Thus, the solid electrolyte membrane 114 may be a highly proton-conductive film. Furthermore, it may be a chemically stable and mechanically strong film. Examples of a preferable material for the solid electrolyte membrane 114 include organic polymers having polar groups including a strong acid group such as a sulfone group and a phosphate group or a weak acid group such as a carboxyl group. Examples of such a organic polymer include condensed aromatic polymers such as a sulfonated poly (4-phenoxybenzoyl-1,4-phenylene), and an alkylsulfonated polybenzoimidazole; sulfonic-containing perfluorocarbons (Nafion® (DuPont), Aciplex® (Asahi Kasei Corporation)); and carboxyl-containing perfluorocarbons (Flemion® S film (Asahi Glass Co., Ltd.)).

The anode 102 or the cathode 108 may have a configuration where an anode-side catalyst layer 106 or a cathode-side catalyst layer 112 containing catalyst-supporting carbon particles and solid-electrolyte particles are formed on a substrate, that is, an anode-side collector 104 or a cathode-side collector 110, respectively.

Examples of a catalyst in the anode-side catalyst layer 106 include platinum, gold, silver, ruthenium, rhodium, palladium, osmium, iridium, cobalt, nickel, rhenium, lithium, lanthanum, strontium, yttrium and alloys of these. A catalyst in the cathode-side catalyst layer 112 used for the cathode 108 may be as in the anode-side catalyst layer 106 and thus may be selected from the above materials. The catalysts in the anode-side catalyst layer 106 and the cathode-side catalyst layer 112 may be the same or different.

The anode 102 or the cathode 108 may have a configuration where the anode-side catalyst layer 106 or the cathode-side catalyst layer 112 containing catalyst-supporting carbon particles and solid electrolyte particles are formed on a substrate, that is, the anode-side collector 104 or the cathode-side collector 110, respectively.

The solid electrolyte particles in the anode-side catalyst layer 106 and the cathode-side catalyst layer 112 may be the same or different. The solid electrolyte particles may be made of the same material as the solid electrolyte membrane 114, or alternatively, may be made of a different material from the solid electrolyte membrane 114 or made of a plurality of materials.

For both anode 102 and cathode 108, the substrate (anode-side collector) 104 and the substrate (cathode-side collector) 110 may be a porous conductive material such as carbon papers, carbon moldings, sintered carbon, sintered metals, foam metals and metal fiber sheets. Among these, a metal such as sintered metals, foam metals and metal fiber sheets can be used to improve collecting properties of the anode 102 and the cathode 108.

A single cell structure 1393 may be manufactured by, but root limited to, for example, the following process.

First, the anode 102 and the cathode 108 are provided. These catalyst electrodes are provided by forming a catalyst layer containing a catalyst substance and a solid polymer electrolyte on a substrate (collector) such as a carbon paper. First, a catalyst is supported on carbon particles by an appropriate catalyst supporting method such as impregnation. Next, the catalyst-supporting carbon particles and a solid polymer electrolyte are dispersed in a solvent to prepare a coating liquid for forming a catalyst layer. The coating liquid is applied to the substrate 104 or the substrate 110, which is then dried to form the anode-side catalyst layer 106 or the cathode-side catalyst layer 112.

An application method of the coating liquid to the substrate 104 or the substrate 110 is not limited. For example, the application method includes brush coating, spray coating and screen printing. The coating liquid can be applied to about 1 μm to 2 mm. Then, the substrate is dried by heating at a suitable heating temperature for a suitable period for a solid polymer electrolyte used.

The solid electrolyte membrane 114 may be prepared by an appropriate method depending on a material used. For example, such a film can be formed by casting a liquid prepared by dissolving or dispersing an organic polymer material in a solvent on a peelable sheet such as polytetrafluoroethylene and then drying it.

The solid electrolyte membrane 114 thus obtained is sandwiched between the anode 102 and the cathode 108, and the combination is hot-pressed to give a membrane-electrode assembly. Herein, the surfaces in both electrodes where catalyst is formed are placed such that they are opposite to the solid electrolyte membrane 114. The hot-press conditions may be selected depending on materials used; for example, a temperature higher than a softening point or glass-transition temperature of the solid polymer electrolyte. Specifically, the conditions are, for example, a temperature of 100 to 250° C., a pressure of 5 to 100 kgf/cm² and a time of about 10 to 300 sec.

The evaporation inhibiting layer 1390 is formed on the surface of the cathode 108 in the membrane-electrode assembly thus prepared. Furthermore, the fuel-permeation inhibiting layer 1392 is formed on the surface of the anode 102. For example, to the surface of the cathode 108 may be adhered a fibrous cellulose sheet member which is to be an evaporation inhibiting layer. Alternatively, on the surface of the cathode 108 may be disposed a porous substrate, on whose surface is then applied a solution of a water-retentive polymer and dried it. Alternatively, the membrane-electrode assembly and the evaporation inhibiting layer 1390 may be placed in a frame and secured by rivets.

Thus, the single cell structure 1393 is provided, where the evaporation inhibiting layer 1390 is formed on the cathode side in the membrane-electrode assembly.

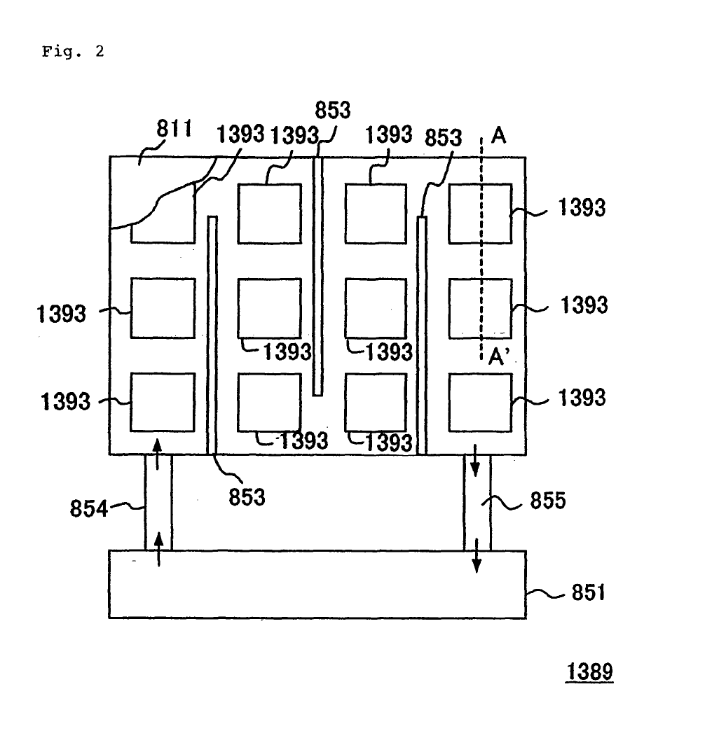

FIG. 2 shows an example of a configuration of a fuel cell having the single cell structure 1393. The fuel cell 1389 shown in FIG. 2 has a plurality of single cell structures 1393, a container 811 for the plurality of single cell structures 1393 and a fuel tank 851 for supplying a fuel to the container 811 and recovering a fuel circulating through the container 811. The container 811 and the fuel tank 851 are communicated through the fuel path 854 and the fuel path 855. The container 811 in FIG. 2 corresponds to the container 425 in FIG. 1.

In this embodiment, a fuel is supplied to the container 811 via the fuel path 854. The fuel flows along a plurality of divider plates 853 within the container 811 to be supplied to the plurality of single cell structures 1393 in sequence. After circulating through the plurality of single cell structures 1393, the fuel is recovered into the fuel tank 851 via the fuel path 855.

### Embodiment 2

Herein, a single cell structure has a configuration basically as in the single cell structure 1393 of FIG. 1, except that two members are used as an evaporation inhibiting layer 1390.

Specifically, next to a cathode is placed a fibrous cellulose sheet as an evaporation inhibiting layer 1390, on which is placed a punching plate having a number of venting pores. The punching plate protects the outer surface of the evaporation inhibiting layer 1390 and more effectively prevent drying of the inside of the evaporation inhibiting layer 1390 from its surface while supplying an oxidizing agent 126 into the single cell structure 1393. Permeation of the oxidizing agent 126 and water can be easily controlled by adjusting a numerical aperture of the punching plate.

The punching plate is preferably a metal plate such as an aluminum plate and a stainless plate having an opening. Alternatively, the punching plate may be a plastic plate such as a PTFE plate having venting pores. A size of the venting pores may be for example 1 μm or more, preferably 10 μm or more, to reliably supply the oxidizing agent 126 to the cathode 108. A size of the pores for supplying an oxidizing agent may be for example 5000 μm or less, preferably 100 μm or less. It can ensure that water is retained in the evaporation inhibiting layer 1390.

### Embodiment 3

In Embodiment 3, a fuel-absorbing member is placed in contact with the outer surface of a limited permeation layer 1392 in a single cell structure 1393 (FIG. 1). In this embodiment, an evaporation inhibiting layer 1390 consists of two members, fibrous cellulose and a punching plate.

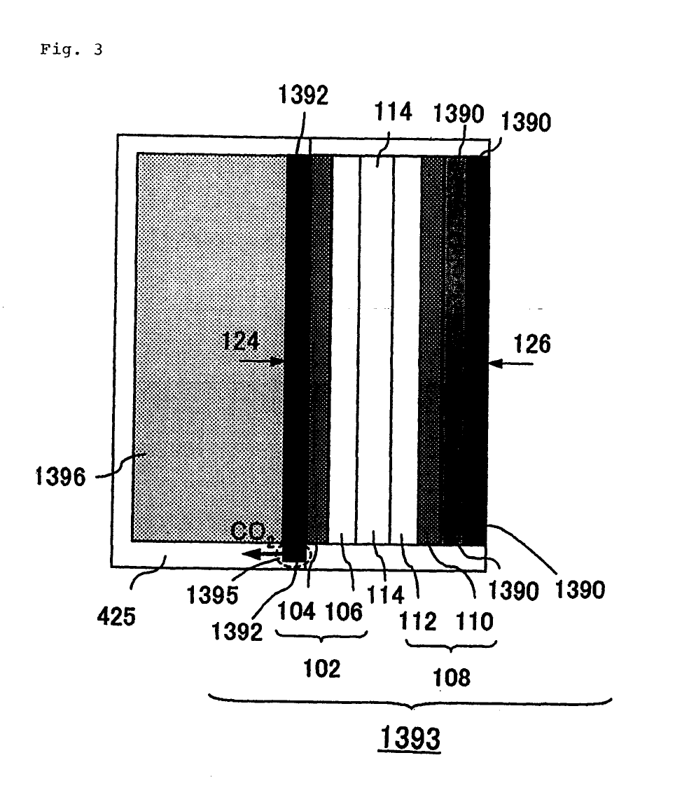

FIG. 3 is a cross-sectional view schematically showing a configuration of a single cell structure as a constitutional unit in a fuel cell according to this embodiment. A single cell structure 1394 shown in FIG. 3 has a configuration as in the single cell structure 1393 shown in FIG. 1, a container 425 adjacent to a limited permeation layer 1392 has a fuel-absorbing part 1396 which is opposite to the limited permeation layer 1392 and is in contact with its outer surface. In the periphery of the surface of the limited permeation layer 1392, there is formed a non-contact part 1395 which is not in contact with the fuel-absorbing part 1396.

The fuel-absorbing part 1396 may be made of a material which can absorb a liquid fuel and have a corrosion resistance to the liquid fuel. The fuel-absorbing part 1396 may be made of a porous material such as a foam. Examples of a material for the fuel-absorbing part 1396 may include polyurethanes, melamine, polyamides such as Nylons®, polyethylene, polypropylene, polyesters such as polyethylene terephthalate, cellulose and resins such as polyacrylonitrile.

The fuel-absorbing part 1396 may be abutted on the outer surface of the limited permeation layer 1392, so that even when a liquid fuel is reduced in the container 425, the liquid fuel absorbed by the fuel-absorbing part 1396 can be surely supplied to the anode 102 via the limited permeation layer 1392. Thus, a fuel cell can be more stably operated. Furthermore, the fuel cell can be stably operated even when a liquid surface of the liquid fuel in the cartridge fluctuates.

There is placed the non-contact part 1395 where a part of the limited permeation layer 1392 is not in contact with the fuel-absorbing part 1396. Thus, in the anode 102, gases such as carbon dioxide generated by the reaction represented by equation (1) can be efficiently discharged to the outside of the limited permeation layer 1392 through the non-contact part 1395. Retention of these gases in the anode 102 can be, therefore, prevented. As described above, the fuel 124 can be efficiently supplied to the anode 102 from the part contacting with the fuel-absorbing part 1396 while substance transfer of the fuel 124 and gases can be more efficient because a path for the gases generated in the fuel electrode 102 is ensured. Thus, output properties of the fuel cell can be improved.

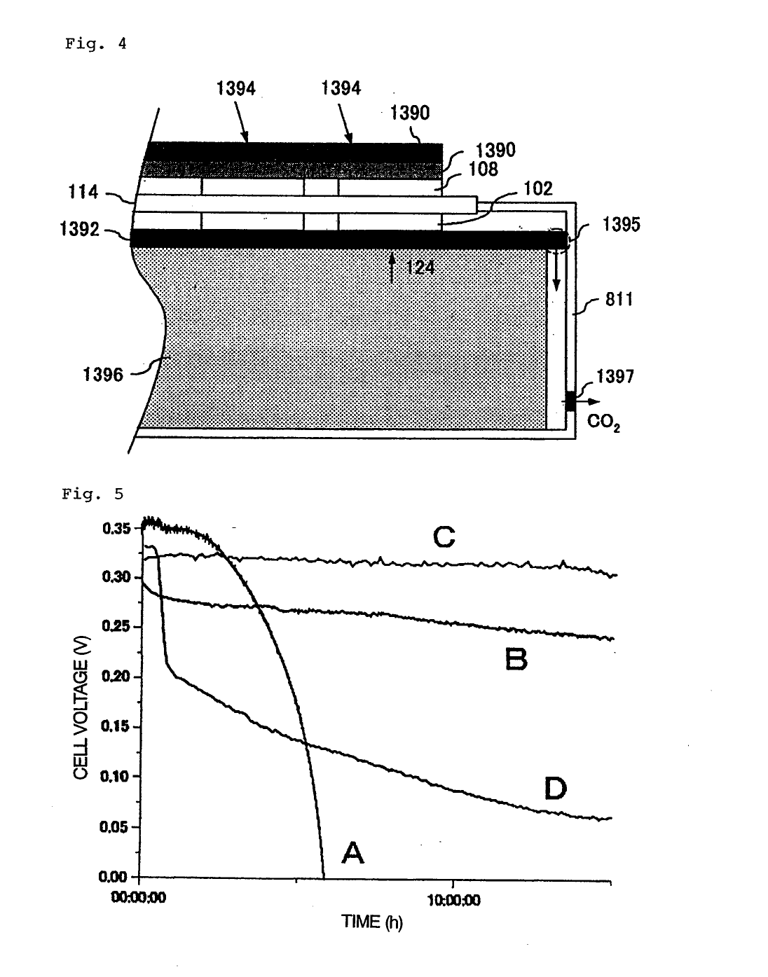

FIG. 4 is a cross-sectional view showing a configuration of a fuel cell having a single cell structure 1394. In the configuration in FIG. 4, a fuel-absorbing part 1396 is formed on the outer surface of one limited permeation layer 1392 constituting each single cell structure 1394 in the fuel cell shown in FIG. 3.

An area near the wall of a container 811 is a non-contact part 1395, and gases generated in an anode 102 move from the anode 102, through a non-contact part 1395, penetrates through a gas-liquid separating film 1397 and are then discharged to the outside of the container 811.

The gas-liquid separating film 1397 may be made of a material selected from, for example, those listed as a material for a PTFE porous gas-liquid separating film. By forming the gas-liquid separating film 1397, leakage of the fuel 124 from the container 811 can be prevented while gases in the anode 102 can be efficiently discharged.

There has been described the present invention with reference to some embodiments. It will be appreciated by one of ordinary skill in the art that these embodiments are provided for illustrative purposes and there may be many variations in a combination of components and processes and that these variations are also within the scope of this invention.

### EXAMPLES

In these examples, four fuel cells having different components were prepared and evaluated for their output properties.

Preparation of a Fuel Cell

First, 100 mg of Ketjen Black supporting a ruthenium-platinum alloy was inactivated with water, and then 3 mL of a 5% Nafion solution (DuPont) was added. The mixture was stirred in an ultrasound mixer at 50° C. for 3 hours to prepare a catalyst paste. The above alloy had a composition of 50 atom % of Ru, and a weight ratio of the alloy and micronized carbon powder was 1:1. The paste was applied to a 1 cm×1 cm carbon paper (TGP-H-120; Toray Industries, Inc.; anode-side collector) in 2 mg/cm², and was dried at 130° C. to give an anode. Using platinum as a catalyst metal, a cathode was prepared as described for the anode.

The catalyst electrodes thus prepared were heat-pressed on both surfaces of a Nafion® 117 (DuPont) film at a temperature of 150° C. and a pressure of 10 kgf/cm² for 10 sec to provide a membrane-electrode assembly.

The membrane-electrode assembly thus prepared was used to prepare fuel cells having the following configurations A to I.

### Comparative Example 1

Cell A: a PTFE sheet (limited permeation layer) was adhered to the outer surface of the anode (the surface opposite to the surface contacting with Nafion 117).

### Example 1

Cell B: a PTFE sheet (limited permeation layer) was adhered to the outer surface of the anode and a fibrous cellulose sheet (evaporation inhibiting layer) was adhered to the outside of the cathode (the surface opposite to the surface contacting with Nafion 117).

### Example 2

Cell C: a PTFE sheet (limited permeation layer) and a fuel absorbing material were sequentially adhered to the outer surface of the anode and a fibrous cellulose sheet (evaporation inhibiting layer) was adhered to the outer surface of the cathode.

### Example 3

Cell D: a fibrous cellulose sheet and a metal plate having holes (evaporation inhibiting layer) were sequentially adhered only to the outer surface of the cathode without placing a PTFE sheet (limited permeation layer) on the outer surface of the anode.

### Example 4

Cell E: a PTFE sheet (limited permeation layer) and a fuel absorbing material were sequentially adhered to the outer surface of the anode and a metal plate having holes (evaporation inhibiting layer) was adhered to the outer surface of the cathode.

### Example 5

Cell F: a PTFE sheet (limited permeation layer) and a fuel absorbing material were sequentially adhered to the outer surface of the anode and a metal plate having holes (evaporation inhibiting layer) was placed outside of the cathode at a distance of a 0.1 mm void.

### Example 6

Cell G: a PTFE sheet (limited permeation layer) and a fuel absorbing material were sequentially adhered to the outer surface of the anode and a plastic plate having holes (evaporation inhibiting layer) was adhered to the outer surface of the cathode.

### Example 7

Cell H: a PTFE sheet (limited permeation layer) and a fuel absorbing material were sequentially adhered to the outer surface of the anode and a porous PTFE plate (evaporation inhibiting layer) was adhered to the outer surface of the cathode.

### Example 8

Cell I: a PTFE sheet (limited permeation layer) and a fuel absorbing material were sequentially adhered to the outer surface of the anode and a foam metal sheet plate (evaporation inhibiting layer) was adhered to the outer surface of the cathode.

### Example 9

Cell J: a PTFE sheet (limited permeation layer) and a fuel absorbing material were sequentially adhered to the outer surface of the anode and a foam metal sheet plate (evaporation inhibiting layer) was placed outside of the cathode at a distance of a 0.1 mm void.

### Comparative Example 2

Cell K: a PTFE sheet (limited permeation layer) and a fuel absorbing material were sequentially adhered to the outside of the anode and a high water-absorptive Unwoven sheet (a fiber diameter expands to 12 folds in comparison with its dry state) was adhered to the outer surface of the cathode.

The fibrous cellulose sheet was the fibrous cellulose sheet with a film thickness of 200 μm, a pore size of 1 μm and a porosity of 80%. The metal plate having holes and a plastic plate having holes were a stainless and a PET plate, in whose whole surface are formed pores with a diameter of 200 μm with a numerical aperture of 80%, respectively. The PTFE sheet was a porous PTFE sheet with a film thickness of 80 μm and a pore size of 300 nm. The foam metal plate was made of an Fe—Cr—Ni alloy with a porosity of 80% and a thickness of 0.2 mm. The high water-absorptive unwoven sheet was made of a polyacrylamide (TOYOBO Co. Ltd., Lancil F). The fuel absorbing material was made of polyurethane.

Evaluation of Cell Properties

Change in a cell voltage in Cells A to D was observed over time. An 30 v/v % aqueous solution of methanol was supplied to an anode in a cell prepared while air (1.1 atm, 25° C.) was supplied to a cathode at a cell temperature of 40° C. Flow rates of a fuel and oxygen were 100 mL/min and 100 mL/min, respectively. Each cell was set in a cell performance evaluation device and a cell voltage in output at a constant current of 1.5 A was determined.

FIG. 5 illustrates variation in a cell voltage in Cells A to D over time. As seen from FIG. 5, Cells B to D (Examples 1 to 3) having a fibrous cellulose sheet and a metal plate having holes on the outer surface of a cathode prevents reduction in a cell voltage during long term use in comparison with Cell A (Comparative Example 1).

Comparing Cells B to D, it can be found that Cell B which was treated in both cathode and anode sides more significantly inhibited reduction in a cell voltage during long term use than Cell D which was treated only in the cathode side. Furthermore, it can be found that in Cell C having a fuel absorbing material in the anode side, a cell voltage is further improved and its reduction was more significantly inhibited.

For a membrane-electrode assembly without anode and cathode treatment, measurement was conducted as described above, and an output was further rapidly reduced in comparison with Cell A. Comparing an initial curve of Cell D with a curve of Cell A, it can be found that Cell A in which only a fuel electrode side was treated prevented reduction in a cell voltage in the initial stage of use to some extent.

Table 1 shows relative fuel consumptions per cell for Cells A to I, cell voltages after 10 hours, and their capability of output maintenance. In Table 1, “control” is a cell in which neither the outer surface of an anode or the outer surface of a cathode was treated. Assuming that fuel consumption in its cell was 1, a fuel consumption in each cell was determined.

Determination of Water-Retaining Ability of an Evaporation Inhibiting Layer

Five and ten hours after the initiation of the evaluation for the above cell properties, an evaporation inhibiting layer was ejected and its weight was compared with that of a control sample to determine water-retaining ability of the evaporation inhibiting layer. A control sample was a sample for an evaporation inhibiting layer having the same size and made of the same material as one of Cells B to J, which was placed under the same temperature-humidity conditions for the same period as the above testing.

As a result, in all of the evaporation inhibiting layers used in Cells B to J, a weight was increased in comparison with a control sample five and ten hours after the initiation of the evaluation, showing that these evaporation inhibiting layers have water-retaining ability.

TABLE 1

| | Control | A | B | C | D | E | F | G | H | I | J | K |
|---|---|---|---|---|---|---|---|---|---|---|---|---|
| Relative fuel | 1 | 0.6 | 0.4 | 0.4 | 0.8 | 0.5 | 0.5 | 0.6 | 0.6 | 0.5 | 0.5 | 0.5 |
| consumption per cell | | | | | | | | | | | | |
| Cell voltage after 10 hrs | | 0 | 0.25 | 0.31 | 0.1 | 0.26 | 0.25 | 0.26 | 0.28 | 0.27 | 0.25 | 0 |
| (V) | | | | | | | | | | | | |

Table 1 shows that Cells A to J reduce a fuel consumption in comparison with the control cell. It also shows that in Cells B and C where a PTFE sheet and a fibrous cellulose sheet are attached to the outer surfaces of the anode and the cathode, respectively, the configurations in the anode and the cathode sides can generate a synergistic effect to particularly reduce a relative fuel consumption.

As shown for Cells E to J, the above effects can be achieved with a fibrous cellulose sheet, a plate with holes (punching plate), a porous PTFE sheet and a foam metal as an evaporation inhibiting layer. In contrast, when using a water-absorbing polymer absorber sheet which excessively absorbs water as an evaporation inhibiting layer, it may not only dry a cathode, but also occlude an oxidizing agent path due to its expansion. Therefore, it is found that an electric power is not emanated although a relative fuel consumption is small.

As described above, a simple configuration where a water-retaining fibrous cellulose sheet and a metal plate having holes are placed on the outer surface of a cathode can reduce fuel wasting and prevent output lowering associated with a long term use. Furthermore, a limited permeation layer and a fuel absorbing material can be disposed in the anode side, to give a fuel cell where fuel wasting is further reduced and a stable output can be achieved for a long period.

1. A solid electrolyte fuel cell comprising a laminate of a limited fuel-permeating part, an anode collector, an anode catalyst layer, a solid electrolyte membrane, a cathode catalyst layer, a cathode collector and an evaporation inhibiting layer in sequence,
wherein the evaporation inhibiting layer is made of a material having venting pores and covers at least part of the surface of the cathode collector.

2. The solid electrolyte fuel cell as claimed in claim 1, wherein the evaporation inhibiting layer comprises a layer consisting of a sheet of laminated fibrous materials.

3. The solid electrolyte fuel cell as claimed in claim 1, wherein the evaporation inhibiting layer is made of a porous material.

4. The solid electrolyte fuel cell as claimed in claim 3, wherein the porous material is a foam metal or polytetrafluoroethylene.

5. The solid electrolyte fuel cell as claimed in claim 1, wherein the evaporation inhibiting layer is comprised of a punching plate.

6. The solid electrolyte fuel cell as claimed in claim 5, wherein the punching plate is made of a metal material.

7. The solid electrolyte fuel cell as claimed in claim 1, wherein a container reserving a liquid fuel supplied to an anode side is placed adjacently to the limited fuel-permeating part.

8. The solid electrolyte fuel cell as claimed in claim 7, wherein the container comprises a fuel-absorbing member which is placed adjacently to a part of the limited fuel-permeating part and absorbs the liquid fuel; and
a part which is not adjacent to the fuel-absorbing member in the limited fuel-permeating part comprises a gas discharging part for discharging a gas generated by a cell reaction.

9. The solid electrolyte fuel cell as claimed in claim 2, wherein a container reserving a liquid fuel supplied to an anode side is placed adjacently to the limited fuel-permeating part.

10. The solid electrolyte fuel cell as claimed in claim 3, wherein a container reserving a liquid fuel supplied to an anode side is placed adjacently to the limited fuel-permeating part.

11. The solid electrolyte fuel cell as claimed in claim 4, wherein a container reserving a liquid fuel supplied to an anode side is placed adjacently to the limited fuel-permeating part.

12. The solid electrolyte fuel cell as claimed in claim 5, wherein a container reserving a liquid fuel supplied to an anode side is placed adjacently to the limited fuel-permeating part.

13. The solid electrolyte fuel cell as claimed in claim 6, wherein a container reserving a liquid fuel supplied to an anode side is placed adjacently to the limited fuel-permeating part.
